(19) United States
(12) Patent Application Publication
(10) Pub. No.: US 2003/0064151 A1
(43) Pub. Date: Apr. 3, 2003

(54) Moisture insensitive electroluminescent phosphor

(75) Inventor: Keith A. Klinedinst, Hudson, MA (US)

Correspondence Address: William H. McNeill, OSRAM SYLVANIA Inc., 100 Endicott Street, Danvers, MA, 01923, US

(73) Assignee: OSRAM SYLVANIA Inc.

(21) Appl. No.: 10/008,730

(22) Filed: Nov. 13, 2001

Related U.S. Application Data
(62) Division of application No. 09/544,125, filed on Apr. 6, 2000, now abandoned.
(60) Provisional application No. 60/128,976, filed on Apr. 12, 1999.

(51) Int. Cl. B05D 5/12; B05D 7/00

(52) U.S. Cl. 427/212; 427/58

(57) ABSTRACT

A phosphor particle has thereon a moisture resistant treatment of a metallic nitride. By moisture resistant is meant a condition allowing the phosphor particle to fiction in a humid atmosphere for a significantly longer period of time than an untreated particle. The method of making such phosphors comprises the steps of introducing an inert gas into a reaction vessel; charging phosphor particles into the reaction vessel; heating the reaction vessel to a reaction temperature. introducing a first precursor compound such as triiosbutyl aluminum and a second precursor compound such as dimetylamine into a second reaction vessel to form a nitride precursor. The nitride precursor is hexakis(dimethylamido)dialuminum The nitride precursor is introduced into the first reaction vessel in a manner to avoid restrictive reactions. A a co-reactant is introduced into the reaction vessel, the inert gas flow, co-reactant flow and precursor supply are mainitained for a time sufficient to make the phosphor particles moisture resistant. The nitride treated phosphor particles produced by this method, which can include the deposition of a nitride coating on the particles, have excellent efficacy ratings and strong luminance values in lamps after 100 hours use in high humidity (i.e., >95%). By avoiding restrictive reactions and by synthesizing the nitride precursor on stream, the method and apparatus can be used to manufacture commercial quantities of coated phosphors at an economical cost.

### CROSS REFERENCE TO RELATED APPLICATION

This application claims priority from Provisional Application No. 60/128,976, filed Apr. 12, 1999.

This application is a division of U.S. patent application Ser. No. 09/544,125, filed Apr. 6, 2000.

### TECHNICAL FIELD

This invention relates to electroluminescent phosphors and more particularly to electroluminescent phosphors that have been treated to be moisture resistant. More particularly, this invention relates to electroluminescent phosphors having greatly reduced moisture absorption, greatly increased life and efficacy, and an economical manufacturing cost.

### BACKGROUND ART

Treated phosphors are known from U.S. Pat. Nos. 4,585,673; 4,825,124; 5,080,928; 5,118,529; 5,156,885; 5,220,243; 5,244, 750; and 5,418,062. It is known from some of the just-mentioned patents that a coating precursor and oxygen can be used to apply a protective coating. See, for example, U.S. Pat. Nos. 5,244,750 and 4,585,673. The treatment processes in several of the others of these patents employ chemical vapor deposition to apply a protective coating by hydrolysis. It also has been reported that chemical vapor deposition, at atmospheric pressure, can be used to deposit thin films of aluminum nitride coatings from hexakis(dimethylamido)dialuminum and anhydrous ammonia precursors upon silicon, vitreous carbon and glass substrates. See, for example, “Atmospheric pressure chemical vapor deposition of aluminum nitride films at 200-250° C.”, Gordon, et al., Journal Material Resources, Vol. 6, No. 1, January 1991; and “Chemical vapor deposition of aluminum nitride thin films”, Gordon, et al., Journal Material Resources, Vol. 7, No. 7, July 1992. See, also, U.S. Pat. Nos. 5,139,825 and 5,178,911, Gordon, which also disclose transition metal nitrides and other metallic nitrides such as gallium and tin, respectively. U.S. Pat. No. 5,856,009 discloses a high temperature process (i.e., 300 to 700° C.) for applying a silicon nitride coating over a previously applied heat resistant coating on phosphor particles. U.S. patent application Ser. No. 09/175,787, filed Oct. 20, 1998 (incorporated herein by reference) and which claims priority from Provisional Application Ser. No. 60/072,510, filed Jan. 12, 1998, discloses a nitride coating process using a highly reactive hexakis(dimethylamido)dialuminum that has been difficult to scale up to commercial quantities. U.S. patent application Ser. No. 09/406,359, filed Sep. 28, 1999 (incorporated herein by reference) discloses a solution to the latter problem; however, a problem still remains relating to the cost of the raw materials employed in the coating process. It would be an advance in the art to provide a process for providing moisture resistant electroluminescent phosphors having a reduced cost for the raw materials, particularly the coating precursor. It would be a further advance if that process operated in the absence of water or water vapor. It would be a further advance in the art to increase the efficacy and the life of such phosphors manufactured by such a process. It would be a still further advance in the art to provide a process that did not rely upon oxygen. It would be a still further advance in the art to provide an electroluminescent phosphor with a non-oxide coating such, for example, as a metallic nitride coating that is applied directly to the phosphor particles at a low temperature, i.e., below 300° C., so that the phosphor performance is not degraded. It would be a still further advance in the art to provide a process employing highly reactive materials that can yield commercial quantities of coated phosphor.

### DISCLOSURE OF INVENTION

It is, therefore, an object of the invention to obviate the disadvantages of the prior art

It is another object of the invention to enhance the operation of moisture-resistant phosphors. 4 Yet another object of the invention is the provision of a method for providing moisture resistant phosphors that does not employ water or water vapor, or oxygen.

Still another object is the provision of a method and apparatus for providing commercial quantities of nitride coated phosphors which method and apparatus employ highly reactive materials.

Still another object of the invention is the provision of a method which reduces the cost of the precursor materials and, thereby the cost of the coated phosphors.

These objects are accomplished, in one aspect of the invention, by the provision of a phosphor particle having thereon a coating of a metallic nitride. The coating may be, and preferably is, conformal to the particle surface. By conformal is meant a coating that follows the surface contours of the individual particles.

The objects additionally are accomplished by a process of preparing moisture resistant particles of electroluminescent phosphor, the steps comprising: introducing an inert gas into a first reaction vessel that is charged with phosphor particles; heating said first reaction vessel to a reaction temperature; introducing a first precursor compound and a second precursor compound into a second reaction vessel to form a nitride precursor; introducing said nitride precursor into said first reaction vessel in a manner to avoid restrictive reactions; introducing a co-reactant into said reaction vessel; and maintaining said inert gas flow, co-reactant flow and precursor supply for a time sufficient to make said phosphor particles moisture resistant.

The objects are further accomplished by the provision of a method of making moisture-resistant phosphors which comprises the steps of introducing an inert gas into a first reaction vessel that is charged with phosphor particles; heating said first reaction vessel to a reaction temperature; introducing a first precursor compound and a second precursor compound into a second reaction vessel to form a nitride precursor introducing said nitride precursor into said first reaction vessel in a manner to avoid restrictive reactions; introducing a co-reactant into said reaction vessel; and maintaining said inert gas flow, co-reactant flow and precursor supply for a time sufficient to make said phosphor particles moisture resistant.

The nitrided phosphor particles have excellent efficacy ratings and strong luminance values in lamps after 100 hours use in high humidity (i.e., >95%) and can be made in viable commercial quantities, such as 50 kg batches, with reduced cost.

### BRIEF DESCRIPTION OF THE DRAWINGS

FIG. 1 is a diagrammatic view of a prior art process for coating the phosphors; and

FIG. 2 is a diagrammatic view of the process of the invention.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

A problem, which previously existed, has been identified as stemming from the reactivity of the nitride precursor, in this case the hexakis(dimethylamido)dialuminum This material reacts with the coarse porosity, fitted glass disk, plating nitrides on the sides of the pores therein. This is particularly true at the elevated temperatures of the reaction vessel, which are in the neighborhood of 150 to 225° C. In very short order the pores of the disk are plugged, stopping the desired reaction of nitride coating on the suspended phosphor particles.

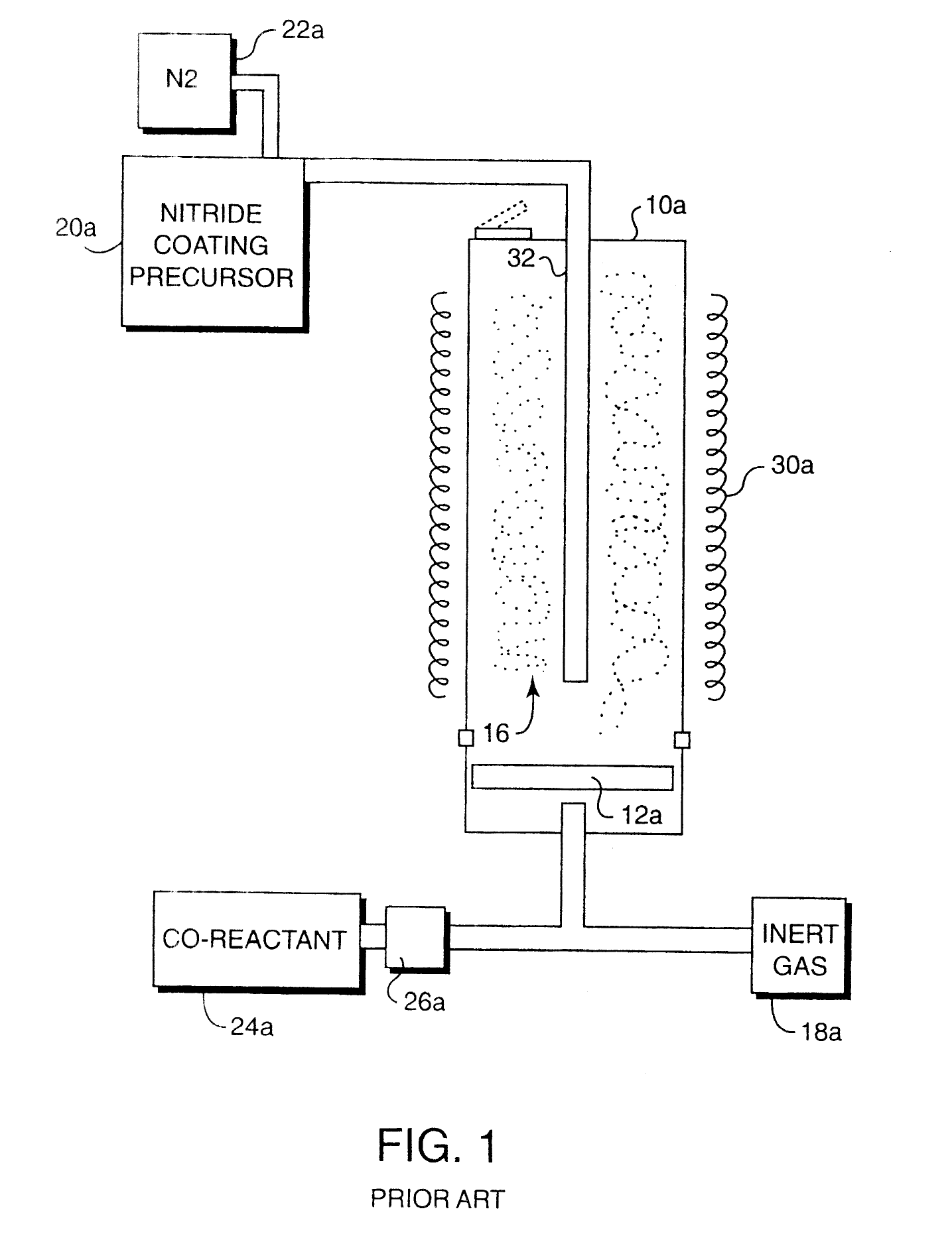

The solution to this problem is presented in the apparatus and method illustrated in FIG. 1. Therein, a reaction vessel 10a, which can be a stainless steel vessel having a diameter greater than 10 inches and being surrounded by a suitable heater 30a to bring the reaction vessel to a coating temperature between 150 and 225° C., has the coating precursor introduced into the vessel in a manner to avoid restrictive reactions. The phosphor 16 is maintained in fluidized form by the injection of an inert gas such as nitrogen or argon from a supply 18a. In the embodiment illustrated, feeding the precursor in a manner to avoid restrictive reactions is accomplished by entraining the precursor from a supply 20a with nitrogen from supply 22a and feeding the entrained precursor from the top of the reaction vessel 10a through tube 32, which is open for its entire length and is not provided with a fritted glass tip. The co-reactant, in this case diluted anhydrous ammonia, can be fed from the bottom of vessel 10a and passed through the porous glass disk 12a. The initial supply of inert gas, which can also be nitrogen and which is used for initially fluidizing the phosphor particles, can also be fed from the bottom of vessel 10a, through disk 12a.

Thus, by feeding the nitride coating precursor in a manner to avoid restrictive reactions, nitride coated phosphors are prepared in commercial quantities in an economic system.

However, the cost of the nitride coated phosphor has been found still to be expensive relative to the commercial market therefor because of the high cost of the nitride precursor, which is attributed to the manner of making it.

A generally employed synthesis route for this material has been described in the literature. This route involves reacting triiosbutyl aluminum with dimethylamine in an autoclave at 190° C. The product is then isolated and purified after removal of the solvent used in the manufacture. This solvent is n-heptane. While the two reactants (triiosbutyl aluminum and dimethylamine) are relatively inexpensive, the high cost of the hexakis product is the result of the time consuming and careful work that must be done to isolate and purify this air-sensitive product.

It is proposed to utilize the relatively low cost of the precursor compounds to reduce the cost of coated phosphors.

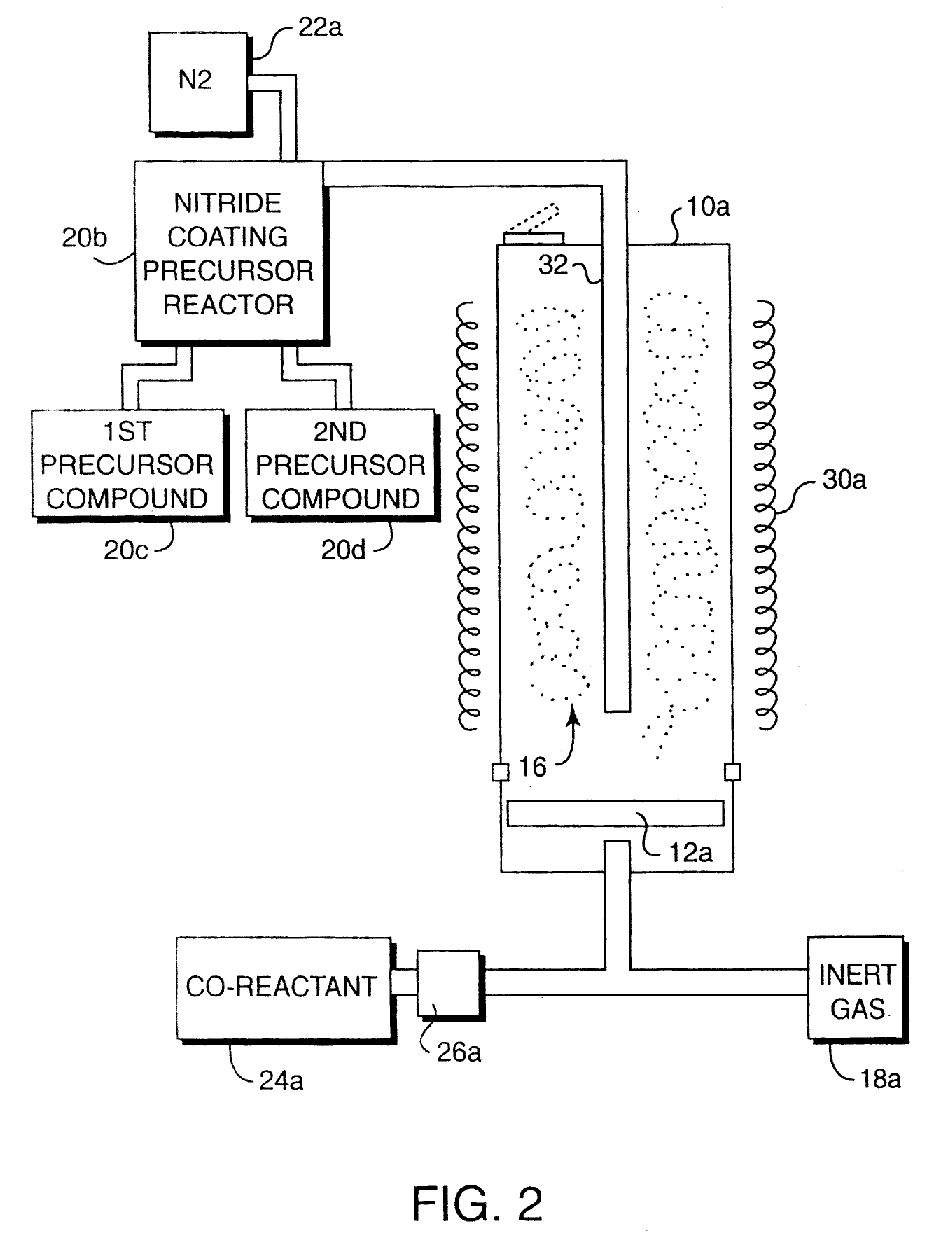

This is accomplished by providing a second reaction vessel upstream from the first or primary reaction vessel 10a to form the nitride precursor on line. This is illustrated in FIG. 2 wherein there is provided a second reaction vessel 20b into which is fed a first precursor compound and a second precursor compound. The first precursor compound, which is stored in a supply 20c, can be a reactive alkylaluminum such as triisobutyl aluminum. By reactive alkylaluminum is meant one which will react favorably within the temperature confines of this system, i.e., below 300° C. The second precursor compound is preferably dimethylamine which is fed into reaction vessel 20b from a supply 20d thereof.

The second reaction vessel 20b preferably comprises a packed bed of, e.g., glass or alumna particles upon which the reaction can take place. The temperature can be higher or lower than the temperature of the first reaction vessel 10a but, preferably, is the same to avoid further heating or cooling of the nitride precursor before it enters the first reaction vessel The alkylaluminum compound may enter the reaction vessel as droplets of liquid or as a vapor. Since the dimethylamine is a gas at temperatures above 6° C., it is preferable that it enters the second reaction vessel as a gas.

By synthesizing the nitride precursor, (in this instance the hexakis(dimethylamido)dialuminum) as an upstream component just prior to its being carried into the first reaction vessel 10a, the cost of the normally very expensive material can be reduced to the cost of the relatively inexpensive reactants.

Thus, the cost of the nitride coated phosphor can be reduced.

While there have been shown and described what are at present considered the preferred embodiments of the invention, it will be apparent to those skilled in the art that various changes and modifications can be made herein without departing from the scope of the invention as defined by the appended claims.

What is claimed is:

1. A process for preparing moisture resistant particles of electroluminescent phosphor, comprises the steps of introducing an inert gas into a first reaction vessel that is charged with phosphor particles; heating said first reaction vessel to a reaction temperature; introducing a first precursor compound and a second precursor compound into a second reaction vessel to form a nitride precursor; introducing said nitride precursor into said first reaction vessel in a manner to avoid restrictive reactions; introducing a co-reactant into said reaction vessel; and maintaining said inert gas flow, co-reactant flow and precursor supply for a time sufficient to make said phosphor particles moisture resistant.

2. The process of claim 1 wherein said first reaction vessel has a porous disk at one end thereof and said nitride precursor is introduced into said reaction vessel so that it does not pass through said disk.

3. An apparatus for manufacturing commercial quantities of nitride coated electroluminescent phosphors via a fluidized bed comprising: a first reaction vessel sized to accommodate said commercial quantities of said phosphor, said first reaction vessel having a first end containing a porous, gas dispersing disk and a second end spaced therefrom; at least a fist supply of an inert gas for initially fluidizing said phosphor, said inert gas being inserted into said vessel through said disk; a supply of a first precursor compound and a supply of a second precursor compound entering a second reaction vessel to form a supply of a nitride coating precursor; a supply of a carrier for entraining said nitride precursor; a supply of a co-reactant, said co-reactant being delivered to said vessel through said disk; and a delivery means for said entrained coating precursor which enters said vessel through said second end.

4. A phosphor particle prepared according to the method of claim 1.

5. The process of claim 1 wherein said first precursor compound is a reactive alkylaluminum.

6. The process of claim 5 wherein said alkylaluminum compound is triisobutyl aluminum.

7. The process of claim 6 wherein said second precursor compound is dimethylamine.

8. The process of claim 7 wherein said nitride precursor is hexakis(dimethylamido)dialuminum.

9. The process of claim 8 wherein said co-reactant is anhydrous ammonia.
